(19) United States
(12) Patent Application Publication
(10) Pub. No.: US 2025/0135353 A1
(43) Pub. Date: May 1, 2025

(54) GAME SYSTEM, AND GAME PROGRAM AND CONTROL METHOD FOR GAME SYSTEM

(71) Applicant: KONAMI DIGITAL ENTERTAINMENT CO., LTD., Tokyo (JP)

(72) Inventors: Yoshihiko NARITA, Tokyo (JP); Atsushi YOSHIDA, Tokyo (JP); Takako ARAI, Tokyo (JP)

(73) Assignee: KONAMI DIGITAL ENTERTAINMENT CO., LTD., Tokyo (JP)

(21) Appl. No.: 19/010,818

(22) Filed: Jan. 6, 2025

Related U.S. Application Data
(63) Continuation of application No. PCT/JP2023/027301, filed on Jul. 26, 2023.

(30) Foreign Application Priority Data
Jul. 28, 2022 (JP) 2022-121010

(51) Int. Cl. A63F 13/63; A63F 13/814

(52) U.S. Cl. CPC A63F 13/63; A63F 13/814

(57) ABSTRACT

A game system that provides a game for simulating training of a training object, which is a game object to be a training target, has: an object accepting unit that accepts selection of an event object associated with an event for changing a parameter indicating a state of the training object; a mode selection unit that selects either an automatic advancement mode or a manual advancement mode in accordance with an operation of a user; and an advancing unit that automatically advances an action to be executed by the training object in the automatic advancement mode, and advances the action in accordance with the operation of the user in the manual advancement mode.

### FIELD OF THE INVENTION

The present invention relates to a game system that provides a game for simulating training of a training object, and a game program and a control method for the game system.

### BACKGROUND OF THE INVENTION

### Description of the Related Art

Patent Literature 1 discloses a game system that provides a game including a success part for training a game character to create an original character and a stadium part for matching against a team of another user. In this game, when the section of the success part is completed, the training of the character is completed, and the character can be used as an original character in a competition in the stadium part.

Patent Literature 2 discloses an electronic device for playing a game in which a game medium is raised in a raising game and the raised game medium is used in a main competition game. In this electronic device, a raising-game-medium acceptance unit accepts selection of a raising game medium selected by a player selected from a group of material game media. Then, an inherited-game-medium acceptance unit accepts selection of an inherited game medium made by the player. In addition, a raising-game execution unit starts the raising game after the raising game medium and the inherited game medium are selected.

As a result of the raising game being started, a defined-type information parameter change unit sums, for each item of expression-defined-type information, predetermined values corresponding to ranks of expression-defined-type information of inherited game media and ancestral raised game media. Then, the defined-type information parameter change unit adds, for each item of defined-type information, a total amount to a raising parameter corresponding to that defined-type information. In addition, the raising-game execution unit executes an inheritance event a predetermined number of times at a predetermined timing while the raising game is in progress. In this inheritance event, a lottery-type information parameter change unit changes a raising parameter corresponding to each item of lottery-type information based on a result of a probability-based lottery.

### CITATION LIST

### Patent Literature

[PATENT LITERATURE 1] JP2017-06280A
[PATENT LITERATURE 2] JP2022-17687A

### SUMMARY OF THE INVENTION

In a game for simulating training of a training object which is a game object, the training object may be caused to perform an action and the like selected by a user. Accordingly, a parameter of the training object increases, and thus the user selects and executes the action a plurality of times before the training is ended. Further, when the training object is caused to perform the action, a performance corresponding to the action is displayed. As a result, a series of processing of selecting and executing the action and displaying the performance is repeated a plurality of times. Since this repeated processing takes a certain period of time, a long period of time is required until the training ends.

A game system according to one aspect is a game system that provides a game for simulating training of a training object, which is a game object to be a training target, the game system comprising: an object accepting unit that accepts selection of an event object associated with an event for changing a parameter indicating a state of the training object; a mode selection unit that selects either an automatic advancement mode or a manual advancement mode in accordance with an operation of a user; and an advancing unit that automatically advances an action to be executed by the training object in the automatic advancement mode, and advances the action in accordance with the operation of the user in the manual advancement mode.

In addition, a game program according to another aspect is a game program for a game system that includes a computer and provides a game for simulating training of a training object, which is a game object to be a training target, the game program causing the computer to function as: an object accepting unit that accepts selection of an event object associated with an event for changing a parameter indicating a state of the training object; a mode selection unit that selects either an automatic advancement mode or a manual advancement mode in accordance with an operation of a user; and an advancing unit that automatically advances an action to be executed by the training object in the automatic advancement mode, and advances the action in accordance with the operation of the user in the manual advancement mode.

In addition, a control method according to still another aspect is a control method for a game system that includes a computer and provides a game for simulating training of a training object, which is a game object to be a training target, the control method comprising causing the computer to execute: accepting selection of an event object associated with an event for changing a parameter indicating a state of the training object: selecting either an automatic advancement mode or a manual advancement mode in accordance with an operation of a user; and automatically advancing an action to be executed by the training object in the automatic advancement mode, and advancing the action in accordance with the operation of the user in the manual advancement mode.

### BRIEF DESCRIPTION OF THE DRAWINGS

FIG. 1 is a schematic diagram illustrating an overall configuration of a game system.

FIG. 2 is a schematic diagram of a top screen of a training part.

FIG. 3 is a schematic diagram of a lesson screen.

FIG. 4 is a schematic diagram of a job screen.

FIG. 5 is a schematic view of a route screen.

FIG. 6 is a schematic block diagram of the game system.

FIG. 7 is a flowchart of task decision.

FIG. 8 is a flowchart of automatic advancement.

### DESCRIPTION OF THE EMBODIMENTS

Hereinafter, exemplary embodiments for carrying out the present invention will be described in detail with reference to the drawings. However, the dimensions, materials, shapes and relative positions of the components described in the following embodiments can be arbitrary set and can be changed according to the configuration of an apparatus or a method to which the present invention is applied or to various conditions. Unless otherwise specified, the scope of the present invention is not limited to the embodiments specifically described below. In the following description, the identification information is data consisting of characters, numbers, symbols, images, or a combination of these.

### EXAMPLES

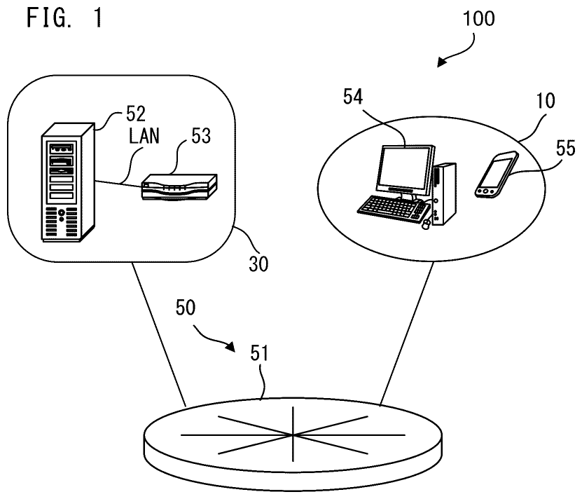

FIG. 1 is a schematic diagram illustrating an overall configuration of a game system 100. As illustrated in FIG. 1, the game system 100 includes a game terminal 10 which is an example of a user terminal, and a server 30. The server 30 is configured as one logical server by combining a plurality of server units 52. However, the server 30 may be configured by a single server unit 52. Alternatively, the server 30 may be logically configured by using cloud computing.

The server 30 is configured to be connectable to a network 50. As an example, the network 50 is configured to implement network communication by using a TCP/IP protocol. Specifically, a local area network LAN connects the server 30 and the Internet 51. Then, the Internet 51 as a WAN and the local area network LAN are connected via a router 53. In addition, the game terminal 10 is also configured to be connected to the Internet 51. The server 30 may be interconnected by the local area network LAN or the Internet 51. Incidentally, the network 50 may be any of a dedicated line, a telephone line, an in-enterprise network, a mobile communication network, other communication lines, combinations thereof, and the like, and may be wired or wireless.

The game terminal 10 is a computer device operated by a user. For example, the game terminal 10 includes a stationary or book type personal computer 54 and a mobile terminal device 55 such as a mobile phone including a smartphone. In addition, various computer devices such as a stationary home game device, a portable game device, a portable tablet terminal device, and a commercial game machine are included in the game terminal 10. The game terminal 10 can cause the user to enjoy various services provided by the server 30 by implementing various types of computer software. Incidentally, an example in which the game terminal 10 is the mobile terminal device 55 will be mainly described below.

As an example, a program and data used for a game are transmitted from the server 30 to the game terminal 10 via the network 50. Then, the game terminal 10 stores the received program and data. Alternatively, the game terminal 10 may be configured to read a program or data stored in an information storage medium (not illustrated). In this case, the game terminal 10 may acquire the program or data via the information storage medium.

The user can play various games on the game terminal 10. For example, this game includes an element for training a game object. Specifically, the game may be a battle type trading card game, a music game, a board game, a mahjong game, an RPG game, a horse racing game, a fighting game, a puzzle game, a quiz game, a sports game such as baseball and soccer, and the like, in addition to a simulation game for simulating training of game objects. In addition, the game objects are targets to be displayed or used in the game terminal 10. As an example, the game objects are used in game processing for progress of the game, and includes a character, a card, an effect, equipment, an item, and the like.

In the following description, an example will be mainly described in which a game for simulating training of a training object which is the game object to be a training target is performed in the game terminal 10. In addition, in this example, a material object, which is the game object serving as a training material, is an idol character imitating a human, and a copy of the character is the training object. That is, a plurality of training objects may exist for the same character. However, the training object may be the character itself that is the material object. In addition, the training object may be a virtual card or the like corresponding to the character.

### [Outline of Game]

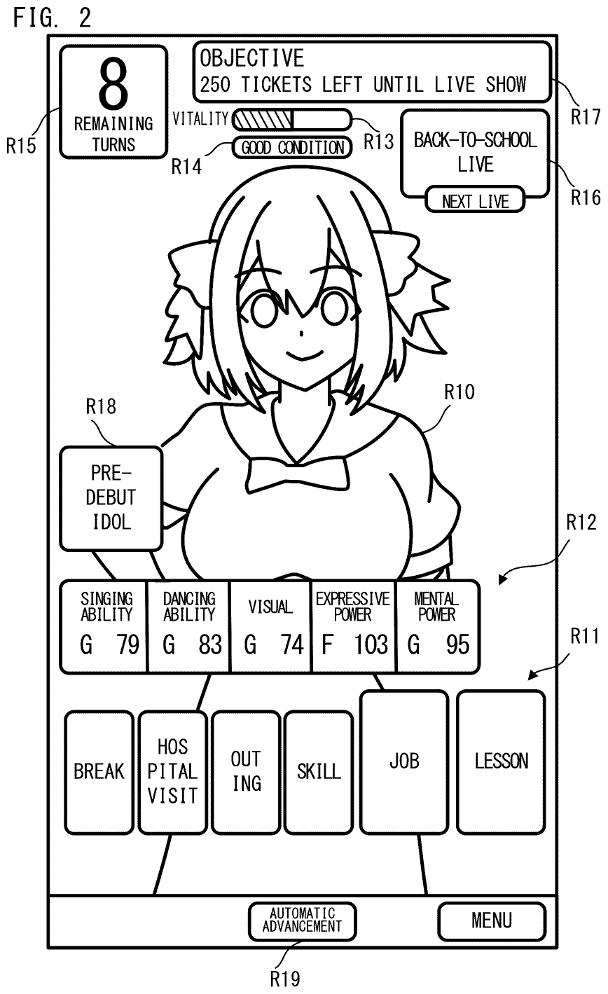

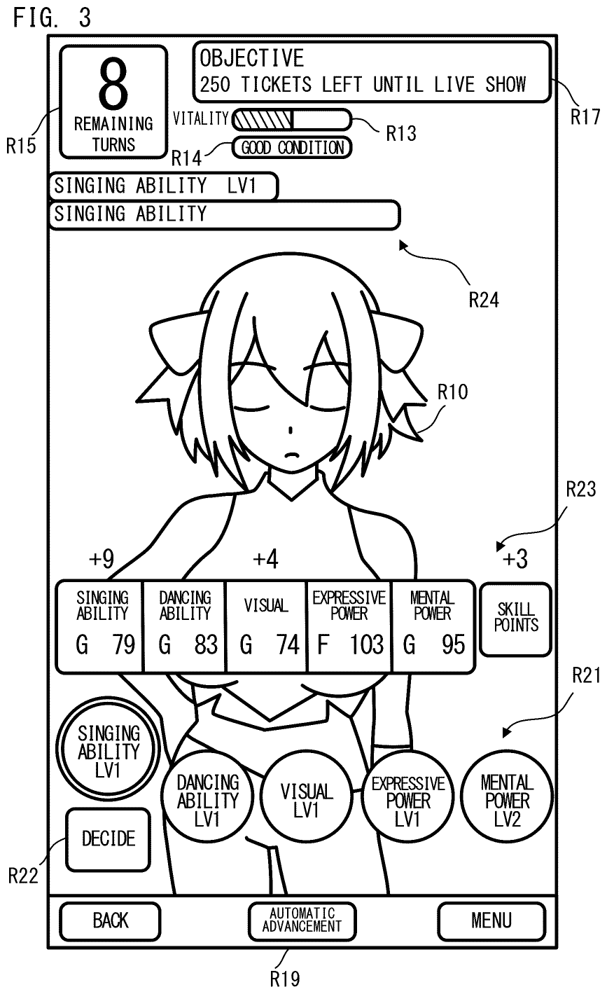

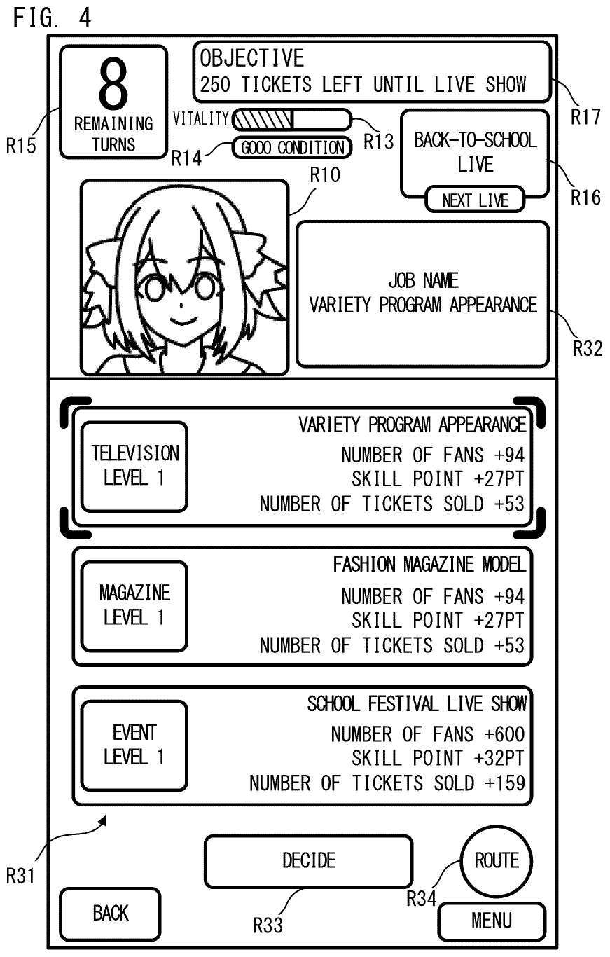

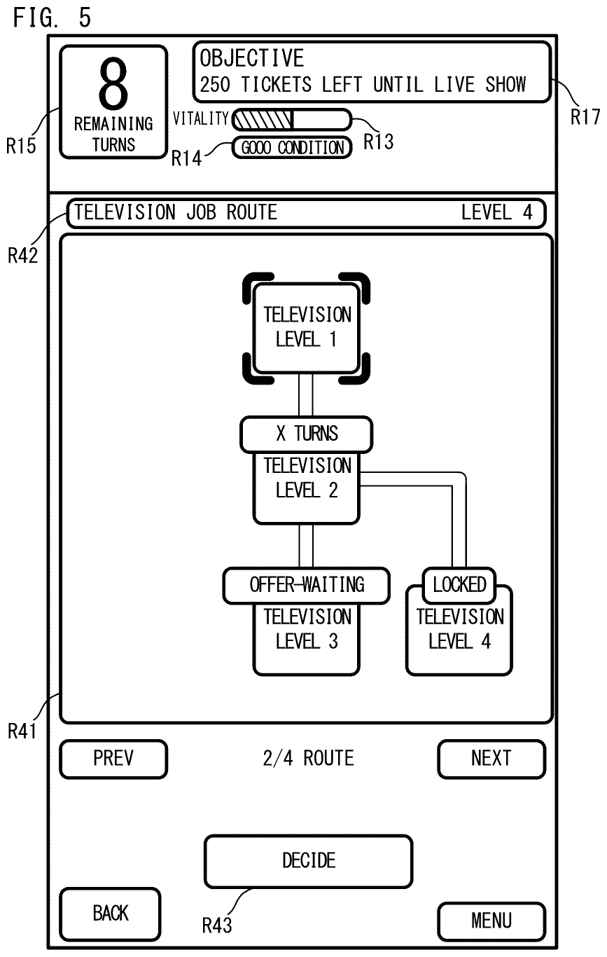

The outline of the game will be described with reference to FIGS. 2 to 5. Incidentally, FIG. 2 is an example of a top screen of a training part. In addition, FIG. 3 is an example of a lesson screen when an action of a lesson is selected. In addition, FIG. 4 is an example of a job screen when an action of a job is selected. In addition, FIG. 5 is an example of a route screen displaying a job route.

The game includes the training part for training the training object, and the training part is divided into a plurality of sections. In addition, each section includes a plurality of turns, and the final turn includes a live part in which the training object performs live. The number of turns included in each section varies depending on the character serving as a material of the training object, a scenario in progress, or the like. Further, in each turn, the training object can be caused to perform a predetermined action. For example, when the training object to be described later is caused to perform the job that is an action of executing work, one turn elapses. In addition, in the training part, an event for the training object may occur at an appropriate timing in each turn. Alternatively, the training part is not necessarily divided for each section. In this case, the training part can include a plurality of turns. In addition, the live part may be provided at the final turn of the training part, instead of providing the live part at the final turn of each section. Further, the live part may be provided separately from the training part.

Before performing the training part, the user selects one or a plurality of event objects as game objects to configure an object group (hereinafter, referred to as a deck). The deck includes a predetermined number (for example, six) of event objects, and the user needs to select the predetermined number of event objects. Alternatively, only an upper limit of the number of event objects may be set. In this case, the user can select a desired number of event objects up to the upper limit. When the deck is configured, a support event may occur with a predetermined probability in the training part. The event object corresponds to the character that is the material object, for example. For example, the event object is the virtual card on which the character is drawn. Then, the support event generated by configuring the deck is associated with the event object. For example, the support event for enhancing singing ability is associated with an event object of the character as a singer, and the support event occurs with a predetermined probability in the lesson for enhancing the singing ability. In addition, a special effect may be generated by a combination of the event objects included in the deck. As an example, when two event objects corresponding to two specific characters are included in the deck, the support event in which the specific characters appear may occur. Incidentally, in the following description, the term “selecting an event object” is referred to as “configuring a deck” in order to be distinguished from selection of an inheritance object to be described later.

In addition, the support event affects training of the training object. That is, in the training part, the support event advantageous for enhancing parameters to be described later occurs according to the event object included in the deck. For example, the support event is an event in which a friend cooperates with the lesson while the training object is taking the lesson. When the support event occurs, an advantageous or disadvantageous effect for training can be obtained. Therefore, the user causes the deck to include the event object corresponding to the support event for enhancing a desired parameter. In other words, the user includes the event object in the deck such that the support event according to a training policy of the user occurs. For example, the advantageous effect is an increase in an amount of parameter enhancement due to the lesson, enhancement of the parameter of the training object, acquisition of a skill, reduction in an amount of a consumption element (for example, skill points to be described later) consumed to acquire the skill, or the like. On the other hand, the disadvantageous effect is, for example, a decrease in the amount of parameter enhancement or degradation in the parameter of the training object.

In the training part, the user trains the training object by causing the training object to perform various actions. That is, the training object gives a performance of taking various actions according to instructions of the user, and as a result, the parameters that are ability values associated with the training object are changed. The parameters are variables associated with object identification information for uniquely identifying the training object, and are changed according to the progress of the game.

In the example illustrated in FIG. 2, a character image R10 representing the training object is displayed. Then, an action region R11 indicating the action performed by the training object is provided so as to overlap a lower part of the character image R10. In this action region R11, “lesson”, “job”, “skill acquisition”, “outing”, “hospital visit” and “break” are displayed. For example, the lesson is an action of enhancing the parameters of the training object. Further, the consumption element consumed to acquire the skill may be acquired by taking the lesson. Examples of the consumption element include the skill points and in-game currency: In addition, the job is the action of enhancing the parameters of the training object or increasing the number of fans or the number of tickets sold.

The skill acquisition is an action of acquiring the skill for advantageously advancing the live part, training of the training object, or progress of various events according to selection of the user. In addition, the outing is an action of enhancing a body condition, which is one of the parameters of the training object, from a low level to a high level. In addition, the hospital visit is an action of canceling out a deteriorated state when a state, which is one of the parameters of the training object, is the deteriorated state. Incidentally, the action of the hospital visit can be selected only when the training object is in the deteriorated state (for example, injured, sick, or the like). Alternatively, the action of the hospital visit may be selectable when the training object is not in the deteriorated state. In addition, the break is an action for recovering vitality which is one of the parameters of the training object.

Incidentally, the action performed by the training object only needs to be an option that produces effects such as a change in the parameter associated with the training object, acquisition or loss of ability or the like, acquisition or use of an item or the like, and a change in relationships with other game objects. For example, as other actions, the training object may be capable of joining a camp, going trip, performing live, having an interview, doing a shoot, appearing, participating in a competition, having an audition, being scouted, going to school, and the like.

In an example of the parameters illustrated in FIG. 2, “singing ability” “dancing ability”, “visual” (for example, a value that rises due to clothes, makeup, hairstyle, or the like), “expressive power”, and “mental power” are illustrated in a parameter region R12. Each of the parameters is indicated by a value of the parameter and a level acquired when the value reaches a predetermined value. For example, in the singing ability in FIG. 2, the parameter value is “79” and the parameter level is “G”. In addition, the skill points, which corresponds to the parameter used for the skill acquisition, may be displayed in the parameter region R12.

As another example, the parameters may include acting ability, playing ability, stamina, intelligence, charm, and the like. Incidentally, the parameter may be information indicating the degree of amount or level of ability, information indicating the presence or absence of ability, or information indicating a state of the game object. In the case of indicating the degree of size or height, the parameter is changed as a value of the parameter increases or decreases. In addition, in the case of indicating the presence or absence of ability, the parameter is changed depending on on/off of a flag.

In the example illustrated in FIG. 2, a vitality bar R13 indicating the vitality parameter and a body condition icon R14 indicating the body condition parameter are illustrated. The vitality is indicated by the proportion of a colored region displayed on the vitality bar R13, and it means that the vitality parameter is higher as the proportion of the colored region of the vitality bar R13 increases. In addition, the body condition icon R14 indicates a current body condition of the training object by a character string displayed on the icon. In the example of FIG. 2, a character string of “good condition” indicates that the body condition is good. This body condition of the training object is divided into a plurality of levels. As an example, the degree of the body condition can be indicated in the order of “terrible”, “bad”, “usual”, “good”, and “excellent”.

In addition, in the training part, the event occurs at a predetermined probability in addition to the support event. As an example of such an event, in the training part, a scenario event according to a predetermined scenario occurs while the training object is taking the action. For example, in the scenario event, a drama depicting a friendship between game objects progresses. In addition, a character event related to the training object may occur. Incidentally, in one turn, a plurality of events may occur, or no event may occur.

In addition, before the start of the training part, an inheritance event that inherits an inheritance element (described later) from the inheritance object selected by the user may occur. Alternatively, the inheritance event may occur in the middle of the training part. Further, the inheritance event may occur both before the start of the training part and in the middle of the training part.

In addition, the live part functions as a checkpoint for confirming the degree of training. This live part occurs in the final turn of each section. In the example of FIG. 2, it is displayed in a checkpoint region R16 that a “back-to-school live” performed in the live part is the checkpoint of the current section. For example, the “back-to-school live” is a mini-game in which a live show where the training object alone or a unit formed of a plurality of game objects including the training object sings is displayed as a performance motion video. In addition, in the example of FIG. 2, in a title region R18, it is indicated that the training object is a pre-debut idol as a title of the training object. As an example, this title changes as the parameter (for example, the number of fans) increases.

Then, a success condition for the live show can be satisfied depending on the parameters of the trained training object or the like. For example, the success condition may be that the singing ability exceeds a predetermined value, that the number of fans or the number of tickets sold exceeds a predetermined number, or the like, or may be that the live show is held. The training can be continued if the success condition is satisfied in the live show, but the training ends if the success condition is not satisfied. In addition, the live show may have a holding condition. In the example of FIG. 2, a condition region R17 indicates the holding condition that the number of tickets sold reaches 250. Incidentally, another condition such as that the singing ability exceeds a predetermined value or that the number of fans or the number of tickets sold exceeds a predetermined number may be the holding condition. The live part can proceed if the holding condition for the live show is satisfied, but the training ends if the holding condition is not satisfied.

As an example, the holding condition for the live show is to acquire a predetermined number of fans, a predetermined number of tickets sold, or the like. Then, the number of fans or the number of tickets sold increases due to execution of the job or occurrence of the event. Therefore, in order to hold the live show, the user needs to cause the training object to perform the job to increase the number of fans or the number of tickets sold.

In addition, a success rate of the live show increases or decreases depending on the parameters of the training object. Therefore, in order to make the live show successful, the user needs to increase the parameters by causing the training object to take the lesson in the training part. Then, if the live show is successful, an effect advantageous for the progress of the game occurs. As an example, the advantageous effect is acquisition of a title (for example, the title “top idol” or the like) that can be inherited. When this title is inherited, an amount of enhancement in a predetermined parameter increases.

In addition, in a job action, the user selects the job, and the training object executes the selected job. The job is an option of the action selectable by the user, and constitutes a part of a job group including a plurality of jobs. As an example, the job group is the job route including a plurality of jobs. This job route is a structure in which the plurality of jobs related to each other are set in a predetermined order. Incidentally, the job is an example of a task. In addition, the execution of the job by the training object includes giving such a performance.

For example, when the job as a starting point of the job route is executed, the training object enters a state in which the next job related to the job is executable. Then, the training object grows with the execution of the job, and the parameters associated with the training object are changed. The plurality of jobs in the job group has, for example, a relationship of a job stage to get a target title (as an example, a top idol). Alternatively, the plurality of jobs has a relationship of following a predetermined scenario (as an example, a drama until a student debuts as an idol). Examples of the job include the live show, an interview, a photo shoot, an appearance, a competition, and an audition.

The training part includes a plurality of sections each including a plurality of turns, and basically one turn progresses each time the training object performs the action. Incidentally, the action to be performed by the training object includes the action that does not consume a turn. For example, even if the skill acquisition action is performed, no turn elapses, and the training object can be still caused to perform another action. In addition, the action that does not consume a turn can also be performed before the start of the live show in a turn of the live part. The number of turns until the training part ends is arbitrary, and as an example, is 72 turns corresponding to 6 years in the game. In the example of FIG. 2, it is displayed that the remaining number of turns is 8 turns in a number-of-turns region R15 indicating the remaining number of turns up to the live part. Then, in the training part including a plurality of turns, the user trains at least one training object in a period including a plurality of turns. That is, the user causes the training object to perform the action (for example, the job) in each turn. Then, the live show is performed in the live part in the final turn of each section. Alternatively, the live show may be performed only in the final turn of the training part. In addition, the live show may be performed after the training part ends, or may be performed in a turn randomly selected in the middle of the training part.

After the training ends, the training object for which the training has ended can be used as the inheritance object. For example, the user selects any character as a succeeding training object to be trained next. Then, the user selects, as the inheritance object, the training object for which the training has ended before the succeeding training object. For example, when the inheritance object is selected, the inheritance element associated with the inheritance object can be inherited by the succeeding training object.

Examples of the inheritance element include a job talent corresponding to the job route, a parameter talent corresponding to the parameter associated with the inheritance object, or the like. In addition, the inheritance element may be information for specifying the job route. For example, identification information for uniquely identifying the job talent is the information for specifying the job route.

### [Flow of Game]

As an example, the game described above progresses as follows. First, the user selects the training object to be trained from among game objects serving as training materials. In addition, the user selects the inheritance object including the inheritance element to be inherited by the training object. For example, the user selects two inheritance objects. However, one or three or more inheritance objects may be selectable. Then, the user selects one or more event objects to configure the deck. For example, the user selects six event objects. However, five or less or seven or more event objects may be selectable. Support events may occur in the training part depending on the event objects included in the deck. Then, the support events may be different from each other, and each of the support events has a predetermined influence on training of the training object.

When the user configures the deck, the training part starts. In the training part, the user selects one action from among the lesson, the job, the break, the hospital visit, and the skill acquisition, and causes the training object to execute the selected action. Specifically, when the training object is in an unhealthy state (for example, sick, injured, or the like), the user selects the hospital visit action in order to resolve the unhealthy state. In addition, when the body condition of the training object becomes worse, the user selects the outing action in order to make the body condition good or excellent from bad. Incidentally, when the training object is in the unhealthy state or in the bad body condition, an effect of the lesson is reduced, or the lesson cannot be selected. When the effect of the lesson is reduced, a decrease in the amount of parameter enhancement, a limitation on the parameter enhancement, parameter degradation, or the like occurs.

When the training object is caused to execute the action selected by the user, one turn progresses. In addition, in the training part, the vitality of the training object increases or decreases. Basically, the vitality of the training object decreases when the lesson or the job is performed. Then, when the vitality is less than a predetermined value, a probability of injury due to the execution of the lesson increases, the effect of the lesson is reduced, or the lesson cannot be selected. Therefore, the user selects the break action and recovers the vitality by a predetermined amount. Incidentally, the vitality may be recovered by occurrence of the event, use of the skill or the item, or the like.

In addition, the user selects the lesson action to enhance the parameters in order to make the live show successful. In the example of FIG. 2, when the user selects a lesson icon in the action region R11, the lesson screen of FIG. 3 is displayed. In the example of FIG. 3, when the user selects an icon indicating the content of the lesson in a lesson region R21, a decision icon R22 is displayed. Then, when the user selects the decision icon R22, the lesson is started. Accordingly, a performance motion video of the lesson is displayed on the screen, and the parameters of the training object increase or decrease as a result of the lesson. In addition, in the lesson region R21, a plurality of lessons that can be executed by the training object are displayed as options on the lesson that can be selected by the user.

In addition, in a variable parameter region R23, values of the parameters that are changed depending on the selected lesson are displayed. In the example of FIG. 3, the variable parameter region R23 indicates that the singing ability increases by 9 points, the visual increases by 4 points, and the skill points increase by 3 points. Further, the content of the currently selected lesson is displayed in a lesson content region R24. In the example of FIG. 3, the lesson content region R24 indicates that a level of the lesson of “singing ability.” is level 1. In addition, levels of the lessons are also displayed in the respective icons of the lesson region R21 in the example of FIG. 3.

### [Job]

Further, the user selects the job action to satisfy the predetermined holding condition such that the live show can be held. When the training object executes the job, the number of fans, the number of tickets sold, or the like increases. In the example of FIG. 2, when the user selects a job icon in the action region R11, the job screen of FIG. 4 is displayed. In the example of FIG. 4, the user selects an icon indicating the content of the job displayed in a list region R31. In this list region R31, a plurality of jobs that can be executed by the training object are displayed as options on the job selectable by the user. Incidentally, in an initial state in which the job screen is displayed, the job displayed at the top of the list region R31 is automatically selected.

In addition, in the list region R31, all the jobs that can be executed by the training object are displayed. Alternatively, some of the jobs that can be executed by the training object are not necessarily displayed in the list region R31. In addition, the job that is not executable by the training object is not displayed in the list region R31. Examples of the job that is not executable by the training object include the job that has not been released and is locked, an offer-waiting job that is the job which has been released but is in a state in which an execution condition of receiving an offer is not yet satisfied, and the job that has been released but does not satisfy an execution condition such as a lapse of a predetermined number of turns. Incidentally, in the list region R31, the job occurring with a predetermined probability may be displayed.

In addition, in the example of FIG. 4, a level and the content of the job and values of parameters that are changed by executing the job are displayed in the list region R31. For example, the content of the job of “television level 1” is an appearance on a variety program. Then, the list region R31 indicates that the execution of the job increases the number of fans by 94, increases the skill points by 27 points, and increases the number of tickets sold by 53. In addition, a name of the selected job is displayed in a job name region R32. In the example of FIG. 4, “variety program appearance” is displayed in the list region R31 as the name of the job. Then, when the user selects a decision button R33, the job is started. Accordingly, a performance motion video of the job is displayed on the screen, and the parameters of the training object increase or decrease as a result of the job.

In addition, when the user selects a route button R34, the route screen illustrated in FIG. 5 is displayed. On the route screen, the selected job is displayed in a relatively emphasized manner as compared with other jobs. In the example of FIG. 5, in route region R41, an icon of the job of “television level 1” is surrounded by a frame to be displayed in an emphasized manner. This emphasized display enables the user to easily recognize at which position on the job route the selected job is located. Alternatively, the emphasized display may be a display that varies in size, transmittance, density, chromaticity, saturation, brightness, shape, hue, or a combination thereof.

In the example of FIG. 5, the job route and jobs included in the job route are displayed in the route region R41. For example, jobs included in a “television job route” are jobs of “television level 1” to “television level 4”. In addition, in a route name region R42, a name of the job route including the selected job and a route level thereof are displayed. The job route includes a plurality of jobs classified by a job type (for example, television, magazine, play; or the like) or content (for example, the appearance, the live show, the photo shoot, or the like).

As an example, the jobs include a one-off job, a plurality of consecutive jobs, an audition job, and a special job (described later). Then, when the user performs a touch operation on a decision button R43, the job is selected and executed. When the training object executes the job, one turn is consumed, and set predetermined vitality decreases. Incidentally, basically, the job that has been executed once cannot be executed again in the training part. As an exception, there may be the job that can be executed a plurality of times.

For example, there is a “handshake event” as an example of jobs that can be selected first as the starting point of the job route. Then, when the training object executes a job of the “handshake event”, a job of a “local handshake event” is released and becomes selectable. Further, when the training object executes the job of the “local handshake event”, a job of a “nationwide handshake event” is released and becomes selectable. Here, the “local handshake meeting” and the “nationwide handshake meeting” are displayed as jobs included in the job route from the initial state.

When the training object executes each job of the plurality of consecutive jobs, one turn is consumed, and set predetermined vitality decreases. Thereafter, the next job can be selected, but the next job is not selectable unless being executed within a predetermined number of turns. Alternatively, the next job may be selectable when a predetermined number of turns elapses. Incidentally, a result of the jobs is displayed when the plurality of consecutive jobs is completed. Alternatively, a result of each of the jobs may be displayed when each of the jobs is completed.

The audition job includes a plurality of consecutive jobs associated with each other. However, the first job is an audition divided into pass and fail based on the parameters of the training object. When the training object passes the audition, the next job becomes selectable. Thereafter, the next job cannot be selected unless being executed within a predetermined number of turns. Alternatively, the next job may be selectable when a predetermined number of turns elapses. Incidentally, a result of the jobs is displayed when the audition job is completed. Alternatively, a result of each of the jobs may be displayed when each of the jobs is completed. On the other hand, when the training object fails the audition, the audition job ends. However, in the case of the failure, the audition, which is the first job, may be selectable again.

For example, an example of the audition job is a “drama audition”. The job of the “drama audition” occurs at a predetermined probability in each turn. Then, when the training object executes the job of the “drama audition” on the turn of occurrence, a result of pass or fail can be obtained based on the parameters of the training object. When the training object passes the job of the “drama audition”, the next job of “first recording” is released and becomes selectable. In this manner, the audition become a starting point of a plurality of consecutive jobs.

In addition, the job routes include a unique job route associated with each training object. Further, the job routes include an inheritance job route that can be selected by inheriting the inheritance element from the inheritance object. In addition, the job routes may include a special job route that occurs for a limited period or when a specific condition is satisfied. Incidentally, jobs not included in the job route include the special job (for example, an appearance on a school festival live show, an appearance on a Christmas event, or an application for awards) that occurs for a limited period or when a specific condition is satisfied.

As an example, the job selectable by the user is defined at the start of the training part. For example, the job selectable by the user is the job included in the unique job route and the inheritance job route, and the user can select the job included in any of the job routes. As an example, it is assumed that the unique job route is an “idol route”. This “idol route” includes jobs of a “live show on streets”, a “music program appearance”, and a “live show in Budokan”. In addition, it is assumed that the inheritance job route is a “model route”. This “model route” includes jobs of a “reader model photo shoot”, an “exclusive model photo shoot”, and a “fashion show appearance”. At the initial stage, the user selects the first job that is the starting point of the job route. Incidentally, the jobs included in the job route may be added or deleted in the middle of the training part.

In the example of FIG. 5, the job route includes branches, so that the job selected by the user can be made different for each training or each training object. Specifically, the user can select any one of the jobs of “television level 3” and “television level 4” after the job of “television level 2” is executed. Alternatively, after one of the branches is selected, the other may be further selectable. Even in this case, the job selected by the user can be made different between a route in which only one of the branches is selected, a route in which only the other of the branches is selected, and a route in which both of the branches are selected. However, the job route does not necessarily include a branch.

In addition, the branch may be generated only when a branch generation condition is satisfied. For example, jobs included in the job route include the job that is always generated and the job that is generated when a predetermined generation condition is satisfied. As an example, the predetermined generation condition is to win a lottery held for each turn, and the job serving as the branch is generated by winning the lottery: Incidentally, the job generated by winning the lottery may be generated on the same route as the existing route, and in this case, no branch is generated. As the job route is provided in this manner, the user can visually perceive a state in which the training object grows by executing different jobs for each training or each training object.

Further, at a point in time when the training part ends, the inheritance element (for example, a gravure idol talent) is associated with the training object based on the executed job. When the training object whose training has been completed is selected as the inheritance object, the inheritance element can be inherited by the next training object. In addition, at a point in time when the training part ends, the title (for example, the gravure idol) may be associated with the training object based on the executed job. As an example, the training part ends when the final live show of the training part ends, when a success condition of the final live show of each section of the training part is not satisfied, when the user performs an operation to end the training, or the like. Then, in either case, the talent or the like corresponding to a state of the training object at the end time point is associated.

In addition, at least one job route is associated with each training object. Therefore, the user can select the job included in at least one job route regardless of which training object is selected. Alternatively, no job route may be associated with the training object at the time of selecting the training object when the job route can be inherited from the inheritance object, or when the job route associated with the event object included in the deck can be selected.

Each job executed by the training object increases the number of fans and the number of tickets sold each of which is one of the parameters. This fact that the number of tickets sold reaches a predetermined value may be a live show holding condition. Further, when the training object executes the job, the singing ability or the like, which is one of the parameters, increases according to the content of the job. On the other hand, when the training object executes the job, the vitality, which is one of the parameters, decreases. Incidentally, the increasing parameter, such as the number of fans, greatly increases when the job succeeds, and slightly increases when the job fails.

In addition, when the training object executes the job, a new job may be executable. That is, execution of the job by the training object may be a release condition for another job. Incidentally, success of the job may be the release condition for another job. Further, execution or success of one or a plurality of jobs may be the release condition for another job route. When the job route is released, the user can select the job included in the released job route.

In addition, as illustrated in FIG. 5, the jobs displayed in the route region R41 include an unreleased job. Specifically, since the job of “television level 4” does not satisfy the release condition, a character string of “lock” is attached. Therefore, the user cannot select the job of “television level 4”. Alternatively, the job that does not satisfy the release condition may be hidden on the route screen. However, since the job included in the job route is displayed in an unselectable manner on the route screen, the user can recognize the job that the training object is to finally execute.

Further, the jobs displayed in the route region R41 include an offer-waiting job. Specifically, the job of “television level 3” cannot be selected due to the state of waiting for an offer, and thus a character string of “offer-waiting” is attached to the icon thereof. In addition, the jobs displayed in the route region R41 includes the job that cannot be selected unless being executed within a predetermined number of turns. Specifically, the job of “television level 2” cannot be selected unless being executed within X turns. This number of turns is indicated by the number of turns attached to the job icon.

In addition, in order to acquire the skill for advantageously advancing the live part or the like, the user selects the skill acquisition action. That is, the user touches the icon of “skill acquisition” displayed in the action region R11 in FIG. 2. As another example, effects exerted by the skill may include an effect of facilitating success of the event or the job, an effect of changing the parameter of the training object, an effect of increasing the amount of enhancement in the parameter by the lesson, and the like.

In addition, when a predetermined number of turns elapses, the live part functioning as the checkpoint is performed. Then, as a result of training, the training can be continued if the success condition is satisfied in the live show, but the training ends if the success condition is not satisfied. Incidentally, the number of checkpoints can be appropriately set. For example, a plurality of checkpoints may be provided and the live part may be performed on the final turn of each section. Then, the training ends when the live part of the final checkpoint ends. When the training ends, the training object can be used as the inheritance object. Further, when a predetermined condition is satisfied, the title (for example, a top model or the like) can be acquired. Then, the acquired title is associated with the training object whose training has ended.

By selecting the trained inheritance object, the job talent, which is an example of the inheritance element, can be inherited by the training object. For example, when the job talent is inherited, the inheritance job route can be selected, and an effect that the job included in the inheritance job route can be selected occurs. In addition, as another effect, a job occurrence probability increases or decreases, and the special job occurs when a predetermined occurrence condition is satisfied. Further, as still another effect, a new job may be added to the unique job route of the training object.

For example, it is assumed that the unique job route of the training object is the “idol route”. The initial “idol route” includes the jobs of the “live show on streets”, the “music program appearance”, and the “live show in Budokan”. In this case, when a “model talent” is inherited, the training object is associated with the “model route” as the inheritance job route. Then, the training object can execute the job included in the inheritance job route. For example, the “model route” includes the jobs of the “reader model photo shoot”, the “exclusive model photo shoot”, and the “fashion show appearance” Incidentally, in a live show of the job selected as an action, a performance (mini-game) in which the training object sings a song is not displayed unlike the live part. Alternatively, the performance may be displayed also in the live show of the job.

As another example, a route level of the “idol route” that is the unique job route is increased by inheriting the “idol talent”. When the route level increases, a new job is added to the job route or a new job is released so as to be selectable. In other words, when the route level increases, the number of jobs that can be selected from the jobs included in the job route increases. For example, as the route level increases, a job of a “nationwide tour” is added to or released from the “idol route.”

### [Game System]

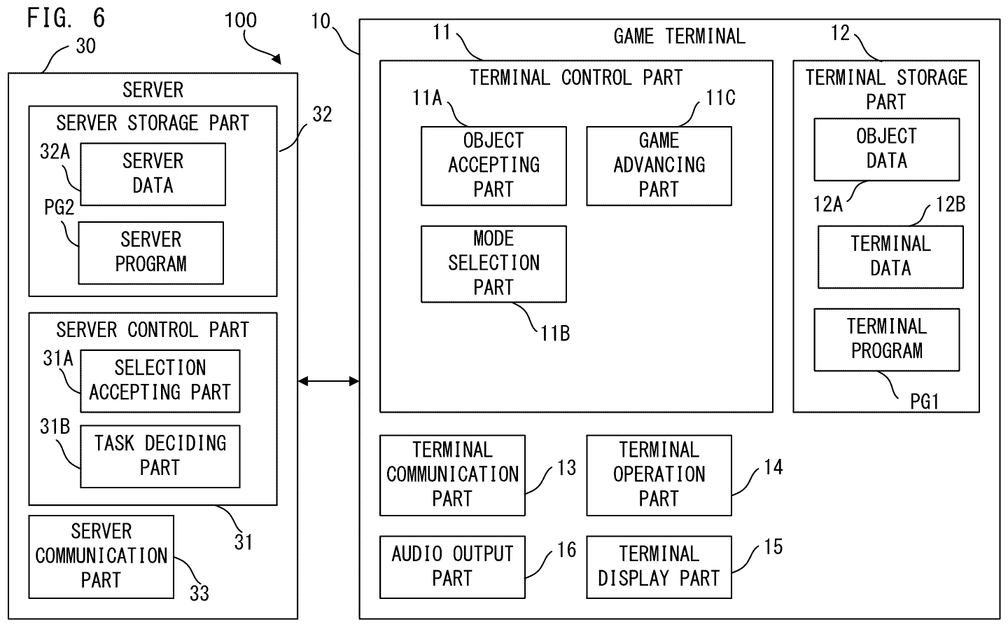

The game system 100 illustrated in FIG. 6 provides a game for simulating training of the training object which is the game object to be the training target by executing each task of a task group including a plurality of tasks. For example, the task group may be a task route in which a plurality of tasks related to each other are set in a predetermined order, and the task route may be branched in a dendrogram. In addition, the job route, which is an example of the task route, includes a plurality of jobs each of which is an example of the task. Then, as the job is executed, the parameters associated with the training object, which is the game object to be the training target, increase or decrease. As illustrated in FIG. 3, the game system 100 includes the game terminal 10 and the server 30.

The user selects the job to be executed from jobs that can be executed by the training object. Accordingly, the training object executes the job included in the job route and aims to finally obtain the title (for example, an idol, an actress, a model, or the like) regarding the job route. Then, the jobs on the job route are advanced, the user can visually recognize the growth of the training object. In addition, an option of a different job is added according to a selected inheritance object even if the training object based on the same character is trained as will be described later. Therefore, a different growth route can be formed for each training or each training object, and variations of the training part can be enriched.

The game terminal 10 includes a terminal control part 11 as an example of a terminal control unit, a terminal storage part 12 as an example of a terminal storage unit, a terminal communication part 13 as an example of a terminal communication unit, a terminal operation part 14 as an example of an operation unit, a terminal display part 15 as an example of a display unit, and an audio output part 16 as an example of an audio output unit. As an example, the terminal control part 11 is configured as a computer, and includes a processor (not illustrated). The processor is, for example, a central processing unit (CPU) or a micro-processing unit (MPU). In addition, the processor controls the entire game terminal 10 based on a control program and a game program stored in the terminal storage part 12, and also controls various processes in an integrated manner.

The terminal storage part 12 is a computer-readable non-transitory storage medium. Specifically, the terminal storage part 12 includes random access memory (RAM) that is a system work memory for the processor to operate, and a storage apparatus such as a read only memory (ROM), a hard disc drive (HDD), and a solid state drive (SSD) that store a program and system software. In the present embodiment, the CPU of the terminal control part 11 executes processing operations such as various calculations, controls, and determinations according to the control program stored in the ROM or the HDD of the terminal storage part 12. Alternatively, the terminal control part 11 can also perform control according to the control program stored in a portable recording medium such as a compact disc (CD), a digital versatile disc (DVD), a compact flash (CF) card, or a universal serial bus (USB) memory; or an external storage medium such as a server on the Internet.

In addition, the terminal storage part 12 stores a terminal program PG1 which is an example of the game program, object data 12A, and terminal data 12B. The object data 12A is data related to the training object that is the game object to be the training target and the inheritance object. For example, the object data 12A includes an image of the character, a parameter value, information indicating a state of the object, and the like which are associated with object identification information for uniquely identifying the object. In addition, the terminal data 12B is data necessary for game processing for progress of the game such as a game image and game music.

The terminal program PG1 causes the terminal control part 11 as a computer to function as an object accepting part 11A which is an example of an object accepting unit, a mode selection part 11B which is an example of a mode selection unit, and a game advancing part 11C which is an example of an advancing unit. That is, the terminal control part 11 includes each unit as a logical device implemented by a combination of hardware and software. Alternatively, the terminal program PG1 can also be stored in another computer-readable non-transitory storage medium other than the terminal storage part 12.

The terminal operation part 14 is an input device to which the user inputs a game operation. In addition, the terminal display part 15 is a device that displays the game image, and is, for example, a liquid crystal display, an organic EL display, or the like. The audio output part 16 is an output device that outputs game music or the like, and is, for example, a speaker, a headphone, or the like. Incidentally, in FIG. 3, the terminal operation part 14 and the terminal display part 15 are illustrated separately: However, the terminal operation part 14 and the terminal display part 15 may be integrally configured as a touch panel. In addition, the terminal operation part 14 may include a touch pad that is not integrated with the terminal display part 15, a pointing device such as a mouse, a button, a key, a lever, a stick, or the like. In addition, the terminal operation part 14 may be a device that detects a voice uttered by the user or a motion of the user and performs the operation according to a detection result.

The server 30 includes a server control part 31, a server storage part 32, and a server communication part 33. The server control part 31 is configured as a computer, and includes a processor (not illustrated). The processor is, for example, a CPU or an MPU, and controls the entire server 30 based on a program stored in the server storage part 32 and also controls various processes in an integrated manner. Alternatively, the server control part 31 can also perform control according to a program stored in a portable recording medium such as a CD, a DVD, a CF card, or a USB memory, or an external storage medium. In addition, the server control part 31 is connected to an operation part (not illustrated) including a keyboard or various switches for inputting predetermined commands and data, in a wired or wireless manner. Moreover, a display part (not illustrated) that causes an input state, a setting state, a measurement result, and various types of information of the device to be displayed is connected to the server control part 31 in a wired or wireless manner.

The server storage part 32 is a computer-readable non-transitory storage medium. Specifically, the server storage part 32 includes a storage apparatus such as a RAM, a ROM, an HDD, and an SSD. In addition, the server storage part 32 stores server data 32A. The server data 32A is data such as image data or music data necessary for the progress of the game, update data of the terminal program PG1, and the like. Further, the server data 32A includes information of the training object or the inheritance object as an example of user information associated with user identification information for uniquely identifying the user. The server communication part 33 is a communication module, a communication interface, or the like. Then, the server communication part 33 enables transmission and reception of data between the game terminal 10 and the server 30 via the network 50.

In addition, the server storage part 32 stores a server program PG2 which is an example of the game program. Then, the server program PG2 causes the server control part 31 as a computer to function as a selection accepting part 31A which is an example of a selection accepting unit and a task deciding part 31B which is an example of a task deciding unit. That is, the server control part 31 includes each unit as a logical device implemented by a combination of hardware and software. Alternatively, the server program PG2 can be stored in another computer-readable non-transitory storage medium other than the server storage part 32.

### [Selection Accepting Unit]

The selection accepting part 31A accepts selection of the inheritance object that is the game object associated with the inheritance element that can be inherited by the training object. The inheritance element is a game element that can be associated with object identification information of the training object. In addition, the inheritance element is a game element that causes a predetermined effect in the training object by being inherited. Then, the inheritance element is used to decide the job route or the job included in the job route. For example, the inheritance element is the job talent, a skill talent, the parameter talent, or the like. Incidentally, the parameter talent may be associated with information of an amount of change for changing the predetermined parameter. When the parameter talent is inherited, a parameter of the training object corresponding to the parameter talent is changed by the amount of change specified by the parameter talent.

As an example, the user selects one desired training object from among a plurality of game objects as training candidates displayed on the terminal display part 15 of the game terminal 10. In addition, the user selects two desired inheritance objects from among a plurality of inheritance objects displayed on the terminal display part 15. Then, the object accepting part 11A of the game terminal 10 accepts the training object and the inheritance objects selected by the user, and transmits respective pieces of object identification information to the server 30. Then, the selection accepting part 31A accepts the selection of the inheritance objects and also accepts the selection of the training object.

Each of the inheritance objects is associated with the job talent as an example of the inheritance element. Then, the task deciding part 31B extracts or draws the job talent of the inheritance object selected by the user, and causes the training object to inherit the job talent. That is, the task deciding part 31B associates the job talent to be inherited with the object identification information of the training object. In addition, the task deciding part 31B includes the associated job talent in the server data 32A for each user to be stored in the server storage part 32. In addition, the task deciding part 31B transmits these pieces of information to the game terminal 10.

When the job talent is inherited, job routes or jobs selectable by the user in the training part increase, or a new job route or job becomes selectable. Therefore, in addition to or instead of jobs of the unique job route serving as individuality of each training object, for example, the inheritance object that has been trained earlier is regarded as a senior, and jobs are inherited from the senior. Accordingly, the user may be made to perceive how a range of jobs increases due to the interpersonal relationship of the senior and a junior or the like.

Further, the selection accepting part 31A accepts selection of the event object that is the game object corresponding to the support event. Specifically, the object accepting part 11A of the game terminal 10 accepts selection of event objects. In addition, the object accepting part 11A transmits object identification information of each of the event objects to the server 30. Then, the selection accepting part 31A accepts the selection of the event objects from the game terminal 10. Incidentally, the support event is the event that affects training of the training object, and occurs at a predetermined probability in the training part. The occurrence of the support event may be decided by selecting the event object.

In addition, the event object is, for example, the virtual card including an image of the character. Alternatively, the event object may be another game object such as the character or the item. As an example, the user selects desired six event objects from a plurality of event objects displayed on the terminal display part 15 to configure the deck. Then, the object accepting part 11A of the game terminal 10 accepts the event objects selected by the user and transmits respective pieces of object identification information to the server 30. Then, the selection accepting part 31A accepts the selection of the event objects.

Each of the event objects is associated with the support event. Then, the task deciding part 31B associates the support event corresponding to the event object selected by the user with the object identification information of the training object. That is, the task deciding part 31B associates event identification information for uniquely identifying the support event with the object identification information. In addition, the task deciding part 31B transmits these pieces of information to the game terminal 10 at the start of the training part. Then, the game advancing part 11C of the game terminal 10 holds a lottery at the start of each turn of the training part, for example, such that the support event occurs according to a lottery result. Incidentally, a timing at which the lottery is held is not limited to the start of each turn, and the lottery may be held at an appropriate timing.

Incidentally, the server control part 31 executes processing of a part of the progress of the game. For example, the server control part 31 executes processing such as the lottery held to acquire the game object during the game. In addition, the server control part 31 manages information of the game object included in the server data 32A. For example, when satisfying a training end condition, the training object can be selected as the inheritance object. Therefore, the server control part 31 causes the training object whose training has ended as the inheritance object to be included in the server data 32A and stored in the server storage part 32.

For example, the condition for ending the training of the training object is to end the live part serving as the final checkpoint. When the training object whose training has ended is saved as the inheritance object, the server control part 31 draws the parameter and the job talent serving as the inheritance element from the parameter and a job execution history of the training object whose training has been completed. Then, the server control part 31 stores the parameter and the job talent as a lottery result in the server storage part 32 in association with the object identification information of the inheritance object. This inheritance object may be usable by the user in other games (for example, a mini-game of the live show that is irrelevant to the training part).

Incidentally, the unique job route of the training object may include the job or the job route that cannot be inherited by other training objects after the end of the training. When the training object associated with a fixed job that is the job that cannot be inherited or a fixed job route including the job route that cannot be inherited, the fixed job or the job included in the fixed job route can be executed. However, the fixed job, the fixed job route, or the job talent that generates the fixed job route is not applied as the inheritance element when the training object is saved as the inheritance object after the end of the training part. Therefore, these are not inherited by the next training object. Accordingly, the job or the like that can be executed only by the training object using a specific character as a material may be provided.

### [Task Deciding Unit]

When selection of the inheritance object is accepted, the task deciding part 31B decides the task that can be executed by the training object from among inheritance tasks corresponding to inheritance elements associated with the selected inheritance object. In addition, the task deciding part 31B decides the task that can be executed by the training object by deciding the task group including tasks and deciding an inheritance task group including the inheritance tasks. For example, the task deciding part 31B extracts or draws the job talent associated with the selected inheritance object, and causes the training object to inherit the job talent. Then, the job talent is associated with the inheritance job route, which is an example of the inheritance task group.

Therefore, the task deciding part 31B can decide the inheritance task route that is the inheritance task group based on the job talent. Accordingly, the task deciding part 31B decides the job, which is a starting point of the inheritance job route, as an inheritance task that can be executed by the training object from among a plurality of jobs, which serve as the inheritance tasks, included in the inheritance job route corresponding to the job talent that is the inheritance element. Then, the task deciding part 31B stores route identification information for uniquely identifying the decided job route in the server storage part 32 in association with object identification information of the training object.

The route identification information of the job route associated with the training object is transmitted to the game terminal 10. Then, the game advancing part 11C presents the jobs included in the job route to the user as options. Alternatively, the task deciding part 31B may decide a single job as an executable job from among the plurality of jobs set corresponding to the job talent. The task deciding part 31B decides a plurality of single jobs, and the job route is configured as a result. In addition, the job routes decided by the task deciding part 31B include a straight route, a route including a branch, and a route generated from a branch point. Incidentally, the inheritance of the job talent is performed when the selection of the inheritance object is accepted and the training part is started. Alternatively, the task deciding part 31B may perform the inheritance of the job talent in the middle of the training part.

In addition, one or more (for example, three) types of unique job routes are associated with each of characters that are material objects. Then, when a plurality of unique job routes is associated, a combination of the plurality of unique job routes associated with the character may be different for each of the characters. In addition, when a single unique job route is associated, the unique job route associated with the character may be different for each of the characters. Alternatively, a common combination of unique job routes may be associated with a plurality of characters, or a common unique job route may be associated with a plurality of characters. Then, the task deciding part 31B may further decide a new job route different from the unique job route and associate the new job route with the training object at the start of the training part or in the middle of the training part.

In addition, a predetermined effect may be generated according to a combination of the unique job route associated with the training object and the job talent inherited from the inheritance object. For example, when the unique job route associated with the training object matches a type of the inherited job talent, the unique job route is changed, and a new job is added or a new job is released so as to be selectable. As an example, when the “idol route” which is a type of job route, is associated as the unique job route, there is a case where the “idol talent” is inherited as the job talent. In this case, since the unique job route matches the type of the inherited job talent, a new job is added to the “idol route” or a new job is released so as to be selectable.

Such a change in the unique job route is processed by the task deciding part 31B according to a change in a route level of the job route. For example, the task deciding part 31B extracts job talents of all selected inheritance characters in order to calculate the route level. Then, the task deciding part 31B adds levels of the same type of job talent to calculate a total value of the levels. Incidentally, the levels of talents may be the route level of the job route at the end of training, or may be decided based on the route level.

The job talent associated with the inheritance object may correspond to the job route that has been executed by the inheritance object in the training part. Accordingly, the training object to be trained next may be caused to execute the job that has been executed by the previously trained training object in the process of training. Therefore, the user can experience the pleasure of training the next training object to be a successor of the previously trained training object and raising the successor. For example, the idol talent is associated with the inheritance object that has executed the jobs of the idol route. In addition, a level of the associated job talent is decided with a predetermined probability. For example, the probability of association is 30% for level 1 of the job talent, 40% for level 2, and 10% for level 3. Then, the probability that the job talent is not associated is 20%. In addition, this probability may increase or decrease depending on the number of jobs executed in the training part.

As an example, when the inheritance object has level 3, level 2, level 2, and level 1 of model talents, a total value of the levels of the model talents is 8. Further, the task deciding part 31B extracts a route level of a job route of the material object and adds the route level to the total value of the levels. For example, when the route level of the material object is level 3, 11 is calculated as a result of the addition. Then, this calculation result becomes the route level of the job route of the training object selected from the material object. In the above-described example, the job route has the route level of 11. Incidentally, a method for inheritance of the job route is not limited to the above-described method using the route level, and a method using another value may be available. In addition, a value to be used is not limited to the total value, and a predetermined value such as a maximum value may be used.

On the other hand, when the unique job route associated with the training object does not match the type of the inherited job talent, a new job route corresponding to the inherited job talent is associated with the training object as the inheritance job route. As an example, when the “idol route” is associated as the unique job route, there is a case where the “model talent” is inherited as the job talent. In this case, the “model route” which is a new inheritance job route is associated with the training object. Incidentally, an upper limit of inheritance routes to be added may be determined, or there may be a restriction on addition of the inheritance routes. For example, there is the restriction on addition when the training object corresponds to a specific character, and the like. That is, an inheritance route that is not added is set to this training object.

In addition, when the task is executed, the task deciding part 31B may further decide another task group associated with the executed task as the task group. For example, a predetermined job is associated with the job route. As an example, the job of the live show in Budokan is associated with a job route of a singer. Then, in the training part, when the training object executes the job of the live show in Budokan, the task deciding part 31B decides the job route of the singer and associates the job route with the training object. Accordingly, the training object may be caused to execute a new job derived from the executed job. In the real world, work derived from experienced work may be arisen, and the user can cause the training object to experience such a chain of work.

Further, when the support event that occurs for the training object occurs, the task deciding part 31B may further decide, as a task group, a subtask group that is a set of tasks to be added and is associated with the support event. For example, event objects configuring the deck are associated with job talents. As an example, when the event object associated with the model talent is included in the deck, the support event in which the event object appears in the training part may occur.

When this support event occurs, the task deciding part 31B associates the model talent with the training object. Then, the task deciding part 31B decides the job route of the model corresponding to the model talent, and associates the job route with the training object as the subtask group. That is, the task deciding part 31B stores route identification information of the job route of the model in association with object identification information of the training object in the server storage part 32. Accordingly, the training object may be caused to execute a new job based on the support event. Incidentally, when the support event occurs, the game terminal 10 transmits event identification information of the support event that has occurred to the server 30.

The association of the subtask group may overlap with the association of the inheritance task group. For example, the same type of job route may be associated with the training object. In addition, the task deciding part 31B may perform the association of the subtask group regardless of the occurrence of the support event. Specifically, the task deciding part 31B may further decide the subtask group associated with the event object as the task group. For example, when the user selects the event object, the task deciding part 31B associates the job route corresponding to the event object with the training object as the subtask group. Accordingly, the training object may be caused to execute a new job based on the event object.

As the job talent is inherited in this manner, different job options for each training or each training object may be provided. Then, as jobs of various lines are executed, the user can visually perceive how the training object is stepped up. For example, the user can select various job routes such as the job route for becoming a gravure idol who finally publishes a photo album. Then, the user can aim at the job that is desirably executed last by the training object trained by the user. In addition, in order to achieve the aim of training, the user can select and enjoy what kinds of jobs are to be executed and which job is to be executed last.

Incidentally, the inheritance element inherited by the training object may be the job talent itself. For example, a live show talent, a television appearance talent, or the like may be inherited by the training object as the inheritance element. In this case, the task deciding part 31B decides the single job as an executable job from among a plurality of jobs set corresponding to the talent to be inherited. Then, when the task deciding part 31B decides a plurality of jobs, the job route is configured as a result.

In addition, the task deciding part 31B may decide the single job regardless of the parameter associated with the training object. For example, when the training object having the model talent inherits the live show talent, the task deciding part 31B decides a live show job that does not exist in the model route. Then, the decided live show job is presented to the user in a selectable manner.

### [Flow of Task Decision]

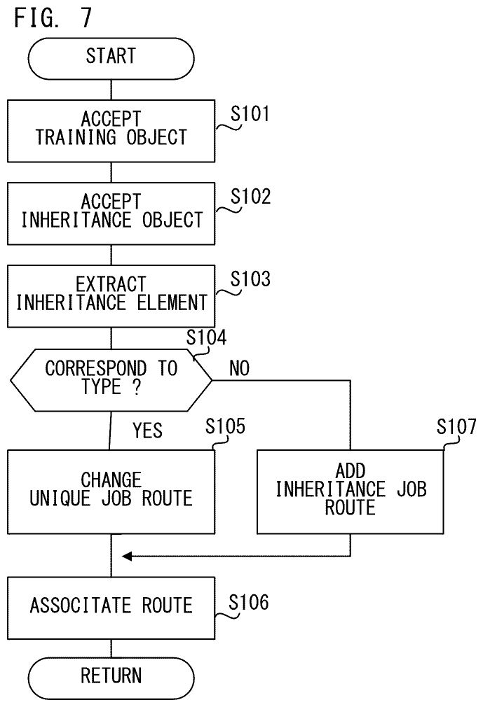

A flow of task decision will be described with reference to FIG. 7. When starting the training part, the user selects the training object from among a plurality of game objects as training candidates displayed on the terminal display part 15 of the game terminal 10. Further, the user selects the inheritance object from among a plurality of inheritance objects displayed on the terminal display part 15. Then, the selection accepting part 31A of the server 30 accepts the selection of the training object transmitted from the game terminal 10 (S101) and accepts the selection of the inheritance object (S102).

Then, the task deciding part 31B extracts the job talent as the inheritance element associated with the selected inheritance object (S103), and causes the training object to inherit the job talent. Here, if a type of the unique job route associated with the training object corresponds to a type of the inherited job talent (YES in S104), the task deciding part 31B changes a route level of the unique job route and decides the job serving as the task which is a starting point thereof (S105). Then, the task deciding part 31B stores route identification information of the decided job route in the server storage part 32 in association with object identification information of the training object (S106). Further, the task deciding part 31B transmits these pieces of information to the game terminal 10. Then, the game advancing part 11C of the game terminal 10 causes these pieces of information to be included in the object data 12A and stored in the terminal storage part 12. Thereafter, the game advancing part 11C simulates training of the training object.

On the other hand, if the type of the unique job route associated with the training object does not correspond to the type of the inherited job talent (NO in S104), the task deciding part 31B adds the inheritance job route and decides the job serving as a task which is the starting point thereof (S107). Then, the task deciding part 31B stores route identification information of the decided job route in the server storage part 32 in association with object identification information of the training object (S106). Further, the task deciding part 31B transmits these pieces of information to the game terminal 10. Then, the game advancing part 11C causes these pieces of information to be included in the object data 12A and stored in the terminal storage part 12. Thereafter, the game advancing part 11C simulates training of the training object.

### [Object Accepting Unit]

Returning to FIG. 6, the object accepting part 11A of the game terminal 10 will be described. The object accepting part 11A accepts selection of the event object associated with the support event which is an example of the event that changes a parameter indicating a state of the training object. For example, the user selects six event objects from among a plurality of event objects displayed on the terminal display part 15. Then, the object accepting part 11A accepts the selection of the event objects and transmits object identification information of each of the event objects to the server 30. As an example, the event objects are virtual cards including images of characters.

In addition, the event objects are associated with support events that change the parameter indicating the state of the training object. For example, the support events occur when the deck including the selected event objects is configured. As an example, the game advancing part 11C holds a lottery at the start of each turn of the training part and generates the support events according to lottery results. Accordingly, the support events that occur in the training part differ depending on the selected event objects, and affects the training of the training object. Then, the user can indicate a training policy of the game object by each of the event objects. Incidentally; the support event associated with the event object not included in the deck may occur in the training part.

### [Mode Selection Unit]

The training part is turn-based, and the user can select the action (for example, the lesson) for each turn. In the training part, the support event corresponding to the event object included in the deck occurs with a predetermined probability. As a result, the parameter associated with the training object increases or decreases. In addition, in each turn, the user can select the job included in the job route and cause the training object to execute the selected job. Incidentally, the user can also alternately execute jobs included in a plurality of job routes.

In the case of a training game in which the training object is caused to execute the action or the like selected by the user such that the parameter is changed, the user selects the action or the like for each turn. Then, a series of processing of causing the training object to execute the action or the like and displaying the performance thereof is repeated a plurality of times. Since this repeated processing takes a certain period of time, a long period of time is required until the end of the training part.

Therefore, the training part of the game provided by the game system 100 is provided with an automatic advancement mode and a manual advancement mode. Then, in the automatic advancement mode, the action to be executed by the training object is automatically advanced. In addition, in the manual advancement mode, the action to be executed by the training object is advanced in accordance with an operation of the user. The mode selection part 11B selects either the automatic advancement mode or the manual advancement mode in accordance with the operation of the user. Incidentally, the automatic advancement mode and the manual advancement mode may have different amounts of change in the parameter based on the execution of the action or the like.

For example, the top screen of the training part illustrated in FIG. 2 and the lesson screen illustrated in FIG. 3 are provided with an automatic advancement button R19 for selecting the automatic advancement mode. Then, every time the user touches the automatic advancement button R19, the mode selection part 11B switches between the automatic advancement mode and the manual advancement mode. Incidentally, the mode selection part 11B may select the automatic advancement mode only while the user is touching the automatic advancement button R19. In this case, the mode selection part 11B selects the manual advancement mode when the user releases a finger from the automatic advancement button R19. Incidentally, the automatic advancement button R19 may be provided on a screen before the start of the training part. Then, the mode selection part 11B selects the automatic advancement mode when the user performs the touch operation on the automatic advancement button R19 before the start of the training part. In this case, when the automatic mode is selected, the training may end without transitioning to the top screen of the training part.

In the automatic advancement mode, at least one action is automatically selected. Then, in the automatic advancement mode, only a result of the action (for example, an increased or decreased parameter) is displayed, and the performance display is skipped. Accordingly, the user can train the training object in a short period of time. Alternatively, in the automatic advancement mode, the selected action and the performance thereof may be automatically advanced. At this time, the performance may be displayed at high speed. Hereinafter, the advancement of the training part in the automatic advancement mode according to these aspects may be simply referred to as automatic advancement.

### [Advancing Unit]

The game advancing part 11C which is an example of the advancing unit simulates the training of the game object. In addition, in the automatic advancement mode, the game advancing part 11C automatically selects and advances the action to be executed by the training object. Then, in the manual advancement mode, the action to be executed by the training object is advanced in accordance with the operation of the user. Further, in the automatic advancement mode, the game advancing part 11C advances the action to change the parameter, and automatically decides the action corresponding to the selected event object. Accordingly, time and effort required for training the game object can be reduced.

For example, when the mode selection part 11B selects the manual advancement mode, the game advancing part 11C accepts the action selected by the user. Then, when the user selects the decision icon R22 (FIG. 3), the game advancing part 11C advances the lesson and increases or decreases the parameter associated with the training object. In addition, the game advancing part 11C displays a motion video or an image of the performance corresponding to the selected lesson on the terminal display part 15. Further, when the user selects the decision button R33 (FIG. 4), the game advancing part 11C advances the job and increases or decreases the parameter associated with the training object. In addition, the game advancing part 11C displays a motion video or an image of the performance corresponding to the selected job on the terminal display part 15.

On the other hand, when the mode selection part 11B selects the automatic advancement mode, the game advancing part 11C automatically selects at least one of actions to be executed by the training object from among actions that can be manually selected by the user. Then, the game advancing part 11C automatically advances the selected action, and increases or decreases the parameter associated with the training object. At this time, the game advancing part 11C may repeat selection of the action and automatic advancement until all the turns of the training part are ended. Alternatively, the game advancing part 11C may repeat selection of the action and automatic advancement over a predetermined number of turns until reaching the checkpoint.

For example, the game advancing part 11C may automatically advances the actions by automatically executing a plurality of the actions which have been decided, in the automatic advancement mode. As an example, the game advancing part 11C automatically advances execution of the selected actions and performance processing thereof. Then, the game advancing part 11C displays performances accompanying the actions at a higher speed than that in the manual advancement mode. Accordingly, the training part ends, and the training of the training object is automatically completed. Alternatively, the game advancing part 11C may display the performances at a lower speed than that in the manual advancement mode or at the same speed as that in the manual advancement mode. In addition, the user may be able to select the display speed of the performances.

In addition, the game advancing part 11C may automatically advances the actions by automatically acquiring parameter change results due to a plurality of the actions which have been decided, in the automatic advancement mode. That is, only values of parameters that have been changed due to the actions or amounts of change in parameters are presented to the user, and the performance display is skipped. As an example, the game advancing part 11C automatically advances execution of the selected actions and performance processing thereof in each turn. At this time, the game advancing part 11C omits the performance display: Then, the game advancing part 11C automatically acquires change results (for example, changed parameter values or the amounts of change in the parameters) and presents the parameters of the training object or the amount of change in the parameters to the user. Accordingly, the time and effort required for training the training object can be reduced. Alternatively, the game advancing part 11C may calculate only increases or decreases in the parameters without performing the performance processing. In addition, the game advancing part 11C does not necessarily present the change results to the user.

Incidentally, when the performance display is omitted, the game advancing part 11C may collectively process the respective actions. That is, the game advancing part 11C may collectively calculate the change in the parameters due to the result of execution of all the actions instead of calculating the change in the parameters due to the result of execution of each of the actions. Accordingly, a processing load on the game terminal 10 can be reduced.

When the actions are collectively processed, the game advancing part 11C may calculate the amount of change in the parameter by the following simplified processing. First, the game advancing part 11C calculates an average number of hospital visits and an average number of times of outing in advance with reference to a training history for each user. Incidentally, the training history is included in the terminal data 12B, for example, and is stored in the terminal storage part 12. Alternatively, the average number of hospital visits and the average number of times of outing may be set in advance. Next, the game advancing part 11C calculates the number of turns consumed by executing the hospital visits based on the average number of hospital visits calculated in advance. Here, on the premise that the unhealthy state is always resolved by execution of a hospital visit, an average number of times of being in the unhealthy state is the average number of hospital visits. In addition, the game advancing part 11C calculates the number of turns consumed by executing the outing based on the average number of times of outing calculated in advance. In addition, the game advancing part 11C calculates a parameter (for example, the number of tickets sold) necessary for satisfying each live show holding condition. Then, the game advancing part 11C calculates the number of turns consumed by executing a necessary job until the parameter is reached.

Then, the game advancing part 11C subtracts a total number of these consumed turns from a total number of turns. Accordingly, the game advancing part 11C calculates the number of turns consumed by executing lessons as a provisional number of lessons. For example, when the total number of turns is 72 turns and the total number of consumed turns is 30 turns, the provisional number of lessons is 42. Further, the game advancing part 11C calculates the number of turns consumed by executing breaks as the number of breaks. As an example, the game advancing part 11C calculates the number of breaks assuming that one break is taken per the provisional number of lessons of 3. Then, the game advancing part 11C calculates the actual number of lessons by subtracting the number of breaks from the provisional number of lessons. For example, when the provisional number of lessons is 42, the number of breaks is 10, and the actual number of lessons is 32. Incidentally, the game advancing part 11C may calculate total consumed vitality by multiplying the number of provisional lessons by average consumed vitality. In this case, the game advancing part 11C calculates the number of breaks by dividing the total consumed vitality by average recovered vitality (for example, 6/10 of an upper limit) that corresponds to vitality when the break is executed once.

Then, the game advancing part 11C calculates ratios of types of parameters associated with the event objects included in the deck. For example, the game advancing part 11C calculates a ratio of each of the singing ability, the dancing ability; the visual, expressive power, and mental power. Here, the game is provided with lessons corresponding to the respective parameter types. Then, the game advancing part 11C calculates the number of individual lessons for each of the parameters in accordance with the calculated ratio. For example, it is assumed that the number of event objects is two for the singing ability; two for the dancing ability, and two for the visual. In this case, the ratio of each of the parameter types to the total of six event objects is 2/6. Therefore, the game advancing part 11C assigns the actual number of 32 lessons to the respective parameter types, and calculates the number of individual lessons for the singing ability as 11, the number of individual lessons for the dancing ability as 11, and the number of individual lessons for the visual as 10. Incidentally, the game advancing part 11C may randomly allocate the respective lessons that are not divisible. In addition, when there is a parameter type that cannot be associated with any event object, an appropriate number of individual lessons may be assigned to the parameter type that cannot be associated.

In addition, the game advancing part 11C calculates an amount of change in each of the parameters per lesson. As an example, the game advancing part 11C temporarily executes lesson processing and adopts the result thereof as the amount of change per one time. Then, the game advancing part 11C multiplies the number of individual lessons corresponding to each of the parameter types by the amount of change to calculate a total amount of change in the parameter. Alternatively, the game advancing part 11C may calculate an average amount of change of each of the parameters per lesson. Incidentally, the game advancing part 11C may use an approximate value instead of the average amount of change. In addition, the game advancing part 11C may correct the calculated amount of change with reference to the event object.

Further, the game advancing part 11C calculates a total amount of change in the parameters due to the job based on the number of turns consumed by executing the job. In addition, the game advancing part 11C calculates a total amount of change in the parameters due to execution of the live show. In addition, the game advancing part 11C holds lotteries as many as the number of turns, and extracts events occurring in the training part. Then, the game advancing part 11C calculates a total amount of change in the parameters due to the generated events.

Finally, the game advancing part 11C calculates a final change amount in the parameters based on the calculated total amount of change of each of the parameters. Then, the game advancing part 11C calculates values of the parameters after the training as a change result based on the final change amount in the parameters and associates the values with the training object. Thereafter, the game advancing part 11C causes the terminal display part 15 to display the change result, and includes the change result in the object data 12A to be stored in the terminal storage part 12. Incidentally, with respect to the skill acquisition action, this may be manually performed by the user after the training is completed, or the game advancing part 11C may automatically execute the skill acquisition action by consuming the skill points.

In addition, the game advancing part 11C changes the parameters of the training object in accordance with the progress of the game. For example, when a lesson for increasing the singing ability is provided in the training part, the game advancing part 11C increases the singing ability of the training object and decreases the vitality of the training object. Then, the game advancing part 11C includes the increased or decreased parameter in the object data 12A in association with the object identification information of the training object to be stored in the terminal storage part 12. Further, the game advancing part 11C transmits the data of the training object to the server 30 at a predetermined timing.

In addition, in the automatic advancement mode, the game advancing part 11C may select the action in accordance with the training policy to automatically advance the training. Specifically, the user can indicate the training policy by the event objects included in the deck. For example, the parameters of the training object change depending on the support events or the like generated by the selected event objects. Therefore, the user selects the event object suitable for a parameter to be changed according to the training policy of the user. Accordingly; the parameter desired to be changed by the user can be estimated based on the event object.

Therefore, the game advancing part 11C automatically selects the lesson for changing the parameter affected by the event object in the automatic advancement mode. As an example, each event object is associated with the parameter type that mainly changes. Then, the game advancing part 11C selects the action (for example, the lesson) by which the parameter type increases. Accordingly, the game advancing part 11C can reflect the training policy of the user in the automatic advancement. Incidentally, the deck may be configured automatically. In this case as well, the user can confirm the content of the deck and indicate the training policy of the user. In addition, the number of event objects referred to by the game advancing part 11C may be one or two or more.

As another example of the automatic advancement, the game advancing part 11C may perform automatic advancement until all the number of turns (for example, 72 turns) elapses in the following manner regardless of which event object is selected. First, the user selects six event objects to configure the deck. Then, the object accepting part 11A accepts the event objects selected by the user. Thereafter, the game advancing part 11C refers to the parameters of the training object, selects and automatically executes predetermined actions.

Specifically, when the training object is in the unhealthy state (for example, injured or sick), the game advancing part 11C selects and executes the hospital visit action. However, when the unhealthy state is caused by the event and the unhealthy state is not resolved by the hospital visit, the game advancing part 11C does not select the hospital visit action. In addition, when the body condition of the training object is “terrible” or “bad”, the game advancing part 11C selects and executes the outing action. Further, when the parameter of the vitality is low (for example, is equal to or less than 4/10 of an upper limit value of the vitality), the game advancing part 11C selects and executes the break action.

In addition, when the live show holding condition (for example, the number of tickets sold reaches a predetermined value) is not satisfied, the game advancing part 11C selects and executes the job action. At this time, the game advancing part 11C selects and executes jobs included in the unique job route of the training object in the order in which the jobs are arranged. In addition, if there are a plurality of unique job routes, the game advancing part 11C selects the job route in the order of arrangement. Further, when there is no selectable job, the game advancing part 11C selects and executes the lesson action.

Alternatively, the game advancing part 11C may select the job on the job route with the highest route level. Alternatively, the game advancing part 11C may select the job on the job route that maximizes a level of the job talent of the training object. Further, the game advancing part 11C may select the job of the job route associated with the character corresponding to the event object.

In addition, when the live show holding condition is satisfied, the game advancing part 11C selects and executes the lesson action. As an example, the game advancing part 11C calculates ratios of types of parameters associated with the event objects included in the deck. For example, the game advancing part 11C calculates the ratio of each of the singing ability; the dancing ability, the visual, expressive power, and mental power. Then, the game advancing part 11C selects and executes the lessons, the number of lessons being set according to the calculated ratio.

As an example, it is assumed that the number of event objects is one for the singing ability; two for the dancing ability, one for the visual, one for the expressive power, and one for the mental power. In this case, the game advancing part 11C selects and executes the lesson for the singing ability once, the lesson for the dancing ability twice, the lesson for the visual once, the lesson for the expressive power once, and the lesson for the mental power once. Then, the game advancing part 11C repeatedly executes these plurality of lessons as a set, and executes the first lesson again when one set is ended.

However, the game advancing part 11C does not necessarily reflect a parameter in selection of the lesson depending on a type of the parameter associated with the event object. For example, when the parameter such as the body condition or vitality is associated, the game advancing part 11C does not reflect the parameter in selection of the lesson. As an example, it is assumed that the number of event objects is two for the visual, one for the expressive power, two for the mental power, and one for the body condition. In this case, the game advancing part 11C ignores the parameter of the body condition and selects and executes the lesson for the visual twice, the lesson for the expressive power once, and the lesson for the mental power twice. Incidentally, there is a case where an option is selected when the event occurs in the middle of the turn or the like. In this case, the game advancing part 11C randomly selects any option or selects the first option.

In addition, the game advancing part 11C may automatically advance only a part of the training part in the automatic advancement mode. For example, the game advancing part 11C may automatically advance only selection and execution of an option of the job or the lesson. Further, the game advancing part 11C may automatically advance only selection and execution of an option of dialog appearing in the event.

Further, selection of the action by the game advancing part 11C may be performed using artificial intelligence (AI) created by machine learning. For example, the game advancing part 11C decides the content of the lesson according to the parameter type associated with the event object. Then, in consideration of timings for selection and execution of the number of lessons, the order, and another action, the optimal actions are automatically executed at optimal timings using AI. A predetermined control routine is implemented in AI, and the optimal action is analyzed by learning using big data to derive an appropriate procedure. Then, the procedure is reflected in the automatic advancement by the game advancing part 11C.

In addition, the game advancing part 11C may automatically decide the action based on the training policy input by the user in the automatic advancement mode. Accordingly, the training policy input by the user can be reflected in the automatic advancement. The input training policy may be specific content or may be simple designation of a lesson type. Alternatively, the training policy by the user may be a policy of selecting and executing the action set by the user up to a predetermined number of turns, and selecting and executing another action set by the user after the predetermined number of turns is reached.

Further, the training policy by the user may be a policy of selecting and executing the lesson for enhancing a set parameter until the parameter reaches a predetermined value, and selecting and executing another lesson set by the user after the predetermined value is reached. Incidentally; the training policy by the user may be indicated using the event object, or may be indicated by a method other than the event object. Further, the game advancing part 11C may execute the automatic advancement such that the predetermined parameter changes by a predetermined amount in the automatic advancement mode. For example, the game advancing part 11C may execute the automatic advancement such that all the parameters are doubled.

In addition, the game advancing part 11C ends the automatic advancement at a timing when the training part ends and the training object that has been trained is saved as the inheritance object, and presents the change result to the user. Alternatively, the game advancing part 11C may end the automatic advancement at a timing when all the turns of the training part are ended. At this timing, actions such as the lesson and the job cannot be executed, but the skill acquisition action can be executed. Therefore, the user can cause the training object to acquire a desired skill.

Further, the game advancing part 11C may interrupt the automatic advancement at any timing according to the operation of the user in the automatic advancement mode. For example, the user performs the touch operation on the automatic advancement button R19 in the middle of the automatic advancement. Then, the game advancing part 11C interrupts the automatic advancement, and the mode selection part 11B selects the manual advancement mode. Accordingly, the user can manually play the training part. Thereafter, the mode selection part 11B may reselect the automatic advancement mode in accordance with the operation of the user. In this case, the game advancing part 11C executes the automatic advancement again.

In addition, the game advancing part 11C may interrupt the automatic advancement at a predetermined timing in the automatic advancement mode. For example, the predetermined timing is a timing at which the event occurs in the middle of the turn, a timing at which the option of dialog is selected, a timing at which the live show occurs, or the like. Alternatively, the game advancing part 11C may interrupt the automatic advancement at a timing when a predetermined number of turns (for example, 10 turns or the like) has elapsed.

Further, in the automatic advancement mode, the game advancing part 11C decides occurrence of the support event, which is an example of the event corresponding to each event object, and automatically advances the support event. Accordingly, the support event corresponding to each event object can be automatically advanced. As an example, the user can select the support events to occur to some extent depending on the event objects included in the deck.

In addition, in the automatic advancement mode, the game advancing part 11C automatically advances another event different from the support events corresponding to the event objects. As an example, another event that is automatically advanced is the event (for example, a scenario event) that occurs in the middle of the turn, or the like. Accordingly, another event different from the support events corresponding to the event objects can be automatically advanced. In addition, the game advancing part 11C automatically advances the live show in the live part in the automatic advancement mode.

In addition, only a part of the training may be affected by the automatic advancement. For example, in the automatic advancement mode, the game advancing part 11C may reflect only a part of the result, which is to be obtained in the manual advancement mode, on a change in the parameters. As an example, the result of the automatic advancement may be reflected only on a change in the skill points, a change in the route level, or a change in the level of the job talent. Accordingly, when the user desires to reflect only a part of the training, the time and effort required for training can be reduced.

### [Audio Output Control Unit]

The game advancing part 11C as an example of an audio output control unit outputs audio based on output sound data of game music or the like to the audio output part 16 as an example of the audio output unit. As an example, the audio output part 16 is a speaker and is configured integrally with the game terminal 10. Alternatively, the audio output part 16 may be separate from the game terminal 10 and may be connected to the game terminal 10 in a wired or wireless manner. Further, the audio output part 16 may be configured integrally with a display device that is separate from the game terminal 10.

### [Flow of Automatic Advancement]

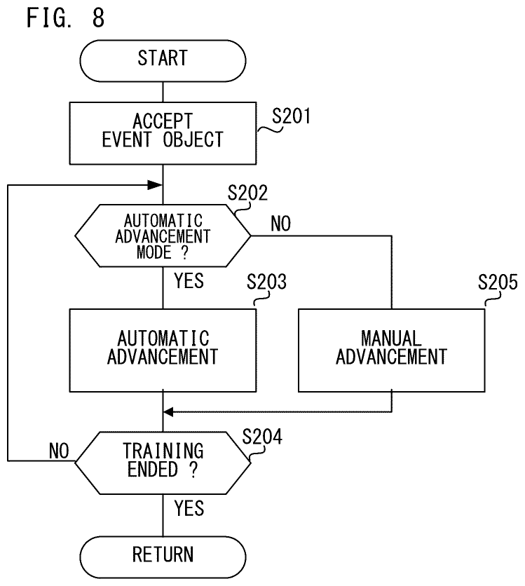

An example of a flow of automatic advancement will be described with reference to FIG. 8. When starting the training part, the user selects a predetermined number (for example, six) of event objects from among a plurality of event objects displayed on the terminal display part 15 of the game terminal 10 to configure the deck. Then, the object accepting part 11A accepts the selection of the event objects (S201). Thereafter, in the training part, if the user touches the automatic advancement button R19 (YES in S202), the mode selection part 11B selects the automatic advancement mode.

Then, the game advancing part 11C executes the automatic advancement in the automatic advancement mode (S203). Thereafter, if the training ends (YES in S204), the game advancing part 11C stores information of the training object in the terminal storage part 12 so as to allow selection as the inheritance object. On the other hand, if the training has not ended (NO in S204), the game advancing part 11C continues the simulation of training.

In addition, in the training part, if the user does not perform the touch operation on the automatic advancement button R19 (NO in S202), the mode selection part 11B selects the manual advancement mode. Then, in the manual advancement mode, the game advancing part 11C accepts selection of the action to be executed by the training object in accordance with the operation of the user and advances the action (S205). Thereafter, if the training ends (YES in S204), the game advancing part 11C stores information of the training object in the terminal storage part 12 so as to allow selection as the inheritance object. On the other hand, if the training has not ended (NO in S204), the game advancing part 11C continues the simulation of training.

The inheritance of the inheritance element in the game system 100 described above can provide diversity of policies for training the training object. In addition, the automatic advancement in the game system 100 described above can reduce the time and effort required for training the game object.

Hitherto, the present invention has been described with reference to each embodiment, but the present invention is not limited to the above embodiments. Inventions modified within a range without contradictory to the present invention and inventions equivalent to the present invention are also included in the present invention. In addition, each embodiment, each modification, and technical means included in each embodiment or each modification can be appropriately combined within a range without contradictory to the present invention.

For example, each of functional parts can be provided in either the server 30 or the game terminal 10. As an example, the selection accepting part 31A and the task deciding part 31B may be provided in the game terminal 10. In addition, the advancing part as the advancing unit, the object accepting part 11A, and the mode selection part 11B may be provided in the server 30. Further, the server control part 31 and the terminal control part 11 may function as a computer in cooperation. When the functional parts are provided in the server 30, safety can be enhanced. On the other hand, when some of the functional parts are provided in the game terminal 10, a load on the server 30 can be reduced. The plurality of functional parts may be provided in a completely separate manner, or some of the functions may be provided separately to function as functional parts. For example, the game terminal 10 may perform inheritance processing, and the server 30 may check a result of the inheritance.

Hereinafter, various aspects derived from the above-described embodiments and modifications will be appended. Incidentally, in order to facilitate understanding of each aspect, reference signs illustrated in the accompanying drawings are described. Note that the reference signs are not intended to limit the present invention to the illustrated form.

### (Supplementary Note 1)

A game system 100 that provides a game for simulating training of a training object, which is a game object to be a training target, the game system 100 comprising:
an object accepting unit 11A that accepts selection of an event object associated with an event for changing a parameter indicating a state of the training object:
a mode selection unit 11B that selects either an automatic advancement mode or a manual advancement mode in accordance with an operation of a user; and
an advancing unit 11C that automatically advances an action to be executed by the training object in the automatic advancement mode, and advances the action in accordance with the operation of the user in the manual advancement mode.

### (Supplementary Note 2)

The game system 100 according to Supplementary Note 1, wherein the advancing unit 11C advances the action to change the parameter and automatically decides the action corresponding to the selected event object in the automatic advancement mode.

### (Supplementary Note 3)

The game system 100 according to Supplementary Note 1, wherein the advancing unit 11C advances the action to change the parameter and automatically decides the action based on a training policy input by the user in the automatic advancement mode.

### (Supplementary Note 4)

The game system 100 according to any one of Supplementary Notes 1 to 3, wherein the advancing unit 11C advances the action to change the parameter, decides occurrence of the event corresponding to the event object, and automatically advances the event in the automatic advancement mode.

### (Supplementary Note 5)

The game system 100 according to any one of Supplementary Notes 1 to 4, wherein the advancing unit 11C automatically advances the action by automatically executing a plurality of the actions which have been decided, or automatically advances the action by automatically acquiring change results of the parameter due to the plurality of the actions which have been decided in the automatic advancement mode.

### (Supplementary Note 6)

The game system 100 according to any one of Supplementary Notes 1 to 5, wherein the advancing unit 11C automatically advances another event different from the event in the automatic advancement mode.

### (Supplementary Note 7)

The game system according to any one of Supplementary Notes 1 to 6, wherein the advancing unit 11C reflects only a part of a result that is to be obtained in the manual advancement mode on a change in the parameter in the automatic advancement mode.

### (Supplementary Note 8)

A game program PG1 for a game system 100 that includes a computer 11 and provides a game for simulating training of a training object which is a game object to be a training target, the game program PG1 causing the computer 11 to function as:
an object accepting unit that accepts selection of an event object associated with an event for changing a parameter indicating a state of the training object:
a mode selection unit that selects either an automatic advancement mode or a manual advancement mode in accordance with an operation of a user; and
an advancing unit that automatically advances an action to be executed by the training object in the automatic advancement mode, and advances the action in accordance with the operation of the user in the manual advancement mode.

### (Supplementary Note 9)

A control method for a game system 100 that includes a computer 11 and provides a game for simulating training of a training object which is a game object to be a training target, the control method comprising causing the computer 11 to execute:
accepting selection of an event object associated with an event for changing a parameter indicating a state of the training object:
selecting either an automatic advancement mode or a manual advancement mode in accordance with an operation of a user; and
automatically advancing an action to be executed by the training object in the automatic advancement mode, and advancing the action in accordance with the operation of the user in the manual advancement mode.

In addition, the following aspects can also be derived from the above-described embodiments and modifications.

### (Supplementary Note 10)

A game system 100 that provides a game in which each task of a task group including a plurality of tasks is executed to simulate training of a training object, which is a game object to be a training target, the game system 100 comprising:
a selection accepting unit 31A that accepts selection of an inheritance object, which is a game object associated with an inheritance element that is inheritable by the training object; and
a task deciding unit 31B that decides, when the selection of the inheritance object is accepted, the task that is executable by the training object from among inheritance tasks corresponding to the inheritance element associated with the selected inheritance object.

### (Supplementary Note 11)

The game system 100 according to Supplementary Note 10, wherein the task deciding unit 31B decides the task that is executable by the training object by deciding the task group including the task and deciding an inheritance task group including the inheritance tasks.

### (Supplementary Note 12)

The game system 100 according to Supplementary Note 10 or 11, wherein, when the task has been executed, the task deciding unit 31B further decides another task group associated with the task that has been executed as the task group.

### (Supplementary Note 13)

The game system 100 according to any one of Supplementary Notes 10 to 12, wherein, when a support event occurring for the training object occurs, the task deciding unit 31B further decides a subtask group associated with the support event as the task group.

### (Supplementary Note 14)

The game system 100 according to Supplementary Note 13, wherein
the selection accepting unit 31A further accepts selection of an event object which is a game object corresponding to the support event, and
the support event occurs by selecting the event object.

### (Supplementary Note 15)

The game system 100 according to any one of Supplementary Notes 10 to 12, wherein
the selection accepting unit 31A further accepts selection of an event object which is a game object, and
the task deciding unit 31B further decides a subtask group associated with the event object as the task group.

### (Supplementary Note 16)

A game program PG2 for a game system 100 that includes a computer 31 and provides a game in which each task of a task group including a plurality of tasks is executed to simulate training of a training object which is a game object to be a training target, the game program PG2 causing the computer to function as:
a selection accepting unit 31A that accepts selection of an inheritance object, which is a game object associated with an inheritance element that is inheritable by the training object; and
a task deciding unit 31B that decides, when the selection of the inheritance object is accepted, the task that is executable by the training object from among inheritance tasks corresponding to the inheritance element associated with the selected inheritance object.

### (Supplementary Note 17)

A control method for a game system 100 that includes a computer 31 and provides a game in which each task of a task group including a plurality of tasks is executed to simulate training of a training object which is a game object to be a training target, the control method comprising causing the computer to execute:
accepting selection of an inheritance object, which is a game object associated with an inheritance element that is inheritable by the training object; and
deciding, when the selection of the inheritance object is accepted, the task that is executable by the training object from among inheritance tasks corresponding to the inheritance element associated with the selected inheritance object.

That is, Patent Literature 1 (JP2017-06280A) discloses a game system that provides a game including a success part for training a game character to create an original character and a stadium part for matching against a team of another user. In this game, when the section of the success part is completed, the training of the character is completed, and the character can be used as an original character in a competition in the stadium part.

In addition, Patent Literature 2 (JP2022-17687A) discloses an electronic device for playing a game in which a game medium is raised in a raising game and the raised game medium is used in a main competition game. In this electronic device, a raising-game-medium acceptance part accepts selection of a raising game medium selected by a player selected from a group of material game media. Then, an inherited-game-medium acceptance part accepts selection of an inherited game medium made by the player. In addition, a raising-game execution part starts the raising game after the raising game medium and the inherited game medium are selected.

As a result of the raising game being started, a defined-type information parameter change part sums, for each item of expression-defined-type information, predetermined values corresponding to ranks of expression-defined-type information of inherited game media and ancestral raised game media. Then, the defined-type information parameter change part adds, for each item of defined-type information, a total amount to a raising parameter corresponding to that defined-type information. In addition, the raising-game execution part executes an inheritance event a predetermined number of times at a predetermined timing while the raising game is in progress. In this inheritance event, a lottery-type information parameter change part changes a raising parameter corresponding to each item of lottery-type information based on a result of a probability-based lottery.

In a game for simulating training of a training object which is a game object, a parameter associated with the training object may increase. As the parameter increases, the training object grows, and the game can progress more advantageously. In addition, the user is often attached to the training object trained by the user. In such a case, the user sometimes desires to cause a training object to be trained next to inherit the parameter of the training object to which the attachment is formed. However, the inheritance of the parameter just leads to the advantageous progress of the game. Therefore, it is required to provide the user with an experience of having attachment to the training object. For this purpose, it is conceivable to increase diversity of policies for training of the training objects.

What is claimed is:

1. A game system that provides a game for simulating training of a training object, which is a game object to be a training target, the game system comprising a computer configured to:
accept selection of an event object associated with an event for changing a parameter indicating a state of the training object:
select either an automatic advancement mode or a manual advancement mode in accordance with an operation of a user; and
automatically advance an action to be executed by the training object in the automatic advancement mode, and advance the action in accordance with the operation of the user in the manual advancement mode.

2. The game system according to claim 1, wherein the computer advances the action to change the parameter and automatically decides the action corresponding to the selected event object in the automatic advancement mode.

3. The game system according to claim 1, wherein the computer advances the action to change the parameter and automatically decides the action based on a training policy input by the user in the automatic advancement mode.

4. The game system according to claim 1, wherein the computer advances the action to change the parameter, decides occurrence of the event corresponding to the event object, and automatically advances the event in the automatic advancement mode.

5. The game system according to claim 1, wherein, in the automatic advancement mode, the computer automatically advances the action by automatically executing a plurality of the actions which have been decided, or automatically advances the action by automatically acquiring change results of the parameter due to the plurality of the actions which have been decided.

6. The game system according to claim 1, wherein the computer automatically advances another event different from the event in the automatic advancement mode.

7. The game system according to claim 1, wherein the computer reflects only a part of a result that is to be obtained in the manual advancement mode on a change in the parameter in the automatic advancement mode.

8. The game system according to claim 1, wherein the computer automatically decides the actions which differ according to a type or number of the selected event object in the automatic advancement mode.

9. A computer-readable non-transitory storage medium storing a game program for a game system that includes a computer and provides a game for simulating training of a training object which is a game object to be a training target, the game program causing the computer to:
accept selection of an event object associated with an event for changing a parameter indicating a state of the training object;
select either an automatic advancement mode or a manual advancement mode in accordance with an operation of a user; and
automatically advance an action to be executed by the training object in the automatic advancement mode, and advance the action in accordance with the operation of the user in the manual advancement mode.

10. A control method for a game system that includes a computer and provides a game for simulating training of a training object which is a game object to be a training target, the control method comprising causing the computer to execute:
accepting selection of an event object associated with an event for changing a parameter indicating a state of the training object;
selecting either an automatic advancement mode or a manual advancement mode in accordance with an operation of a user; and
automatically advancing an action to be executed by the training object in the automatic advancement mode, and advancing the action in accordance with the operation of the user in the manual advancement mode.
